(19) United States
(12) Patent Application Publication
(10) Pub. No.: US 2026/0074473 A1
(43) Pub. Date: Mar. 12, 2026

(54) RF MULTI CONNECTOR UNIT FOR ANTENNAS, ANTENNA SYSTEM AND BASE STATION

(71) Applicant: Telefonaktiebolaget LM Ericsson (publ), Stockholm (SE)

(72) Inventors: Philipp PONN, Kolbermoor (DE); Benjamin ZIMMERLE, Uebersee (DE); Maximilian OBERMAYER, Wörgl (AT); Matthias STECKER, Brannenburg (DE); Mario GÜNTHER, Kolbermoor (DE)

(21) Appl. No.: 19/159,786

(22) PCT Filed: Feb. 1, 2024
(86) PCT No.: PCT/EP2024/052448

§ 371 Date: Aug. 26, 2025

(30) Foreign Application Priority Data
Feb. 28, 2023 (WO) PCT/EP2023/054965

(51) Int. Cl. H01R 24/52; H01R 24/42

(52) U.S. Cl. CPC H01R 24/52; H01R 24/42; H01R 2201/02; H01R 2201/24

(57) ABSTRACT

The present invention relates to an RF multi connector unit for multi-band antennas, an antenna system comprising said RF multi connector unit and a base station including at least one such antenna system. The RF multi connector unit comprises multiple RF-plug connectors (111, 112, 113, 114; 121, 122. 123. 124) being arranged in an array (110; 120) defining a common mating direction (A). At least one of the multiple RF-plug connectors (111, 112, 113, 114; 121, 122, 123, 124) is configured to electrically connect an antenna element of a multi-band antenna (10) with a port of a radio unit, when being plugged to the port. Further, at least one of the multiple RF-plug connectors (111, 112, 113, 114; 121. 122. 123. 124) is supported floatingly, at least in a plane being perpendicular to the mating direction (A).

### TECHNICAL FIELD

The present invention relates to an RF multi connector unit for multi-band antennas, an antenna system comprising said RF multi connector unit and a base station including at least one such antenna system.

### BACKGROUND

Nowadays, mobile communication has become a crucial part of our daily lives. To implement mobile communication services for users and mobile devices, base stations play an essential role to constitute a complete network system by transmitting signals.

A base station (or base radio station) is a transceiver connecting a number of other devices to one another and/or to a wider area. In mobile communications a base station provides the connection between user terminals (e.g. mobile phones, tablet computers, and the like) and/or other IoT devices (such as cars, drones, industrial and agricultural machines, robots, home appliances, medical devices, and the like) and/or the wider cellular network.

A base station may include the following components: (i) at least one base station antenna, (ii) a radio unit, (iii) a base band unit and (iv) a physical support. Further, there may be a remote control unit, allowing the antenna to be controlled remotely, e.g. for adjusting phase shifter(s) of the antenna, to provide for additional functionality, such as remote electrical tilt (RET).

The base station antenna(s) may be a passive antenna, particularly a passive multi-band antenna, which covers multiple frequency bands. Base station antennas used for wireless communication base stations are typically composed of multiple radiators (antenna elements) so as to enable radio frequency cellular communication with an improved transmission range and/or with distinct frequency bands. Such radiators may be formed as dual polarized radiators, such as dual polarized dipole radiators. Each of the antenna elements has to be electrically connected to a respective port of a radio unit for receiving/transmitting Rx/Tx signals.

The radio unit (also denoted as RRU, Remote Radio Unit, or RRH, Remote Radio Head) may be divided into several sub-units (or sectors) for the transmission of e.g. 2G, 3G, 4G and/or 5G signals. The signal generation and extraction of radio signals are typically performed here. Those radio units have become one of the most important components of today's (distributed) base stations. The radio unit typically contains the base station's RF circuitry, analog-to-digital/digital-to-analog converters and up/down converters. Typical radio units also have operation and management processing capabilities and a standardized optical interface to connect to the rest of the base station.

For connecting the radio unit to the antenna (antenna elements, respectively) typically radial-contact connectors are used (e.g. coaxial RF connectors). Connector systems, such as 4.3-10, 2.2-5, 1.5-3.5, the NEX10® connector system and/or the like are commonly used. These connectors allow electrically connecting the radio unit with the antenna, particularly if the connector system is mounted directly floating. State of the art are RF-jumper cables between antenna (respectively antenna elements) and radio unit (respectively ports thereof) on the mast. A standard setup would e.g. be a radio unit being fixed below the antenna on the mast via ½ inch, ¼ inch or ⅜ inch RF-jumper cables.

The base band unit (BBU) is typically located remote from the radio unit (e.g. in a separate equipment room) and may be connected with the radio unit via an optical fiber, a dedicated high bandwidth wire or other suitable connections. The BBU processes an original signal.

The physical support mainly includes an electrical power system, which may include a backup battery (to prevent power failure), a transmission equipment, and further optionally an air conditioning system to maintain the optimal temperature for regular operation.

For the base station to work properly, it is crucial that the antenna elements of a base station antenna are correctly connected to respective ports of a radio unit, as each port is assigned to a specific one of the antenna elements. In case the ports are interchanged (connected incorrect), the base station does not work properly so the available radiated power is reduced and additional functions, such as phase shifting, are disturbed. Further, the radio unit and/or antenna element may even get damaged due to an incorrect wiring.

Incorrect wiring is in particular an issue, as each base station and/or base station antenna is configured individually. Hence, assembling and setting up a base station/base station antenna implies a huge workload for the workers, including correct routing and connecting every single cable between the antenna and respective radio units. Despite the highest case, there is always a risk of incorrect connections. Further, providing a huge number of cables, complicates maintenance work, as the set-up becomes very complex.

To provide for an easier set-up, RF multi connector systems are known. For example, EP 3 829 006 A1 suggests an RF multi connector system that comprises a multi plug connector and a multi socket connector. The multi plug connector comprises a plurality of first connectors circularly arranged around a center axis. The multi socket connector comprises a plurality of second connectors circularly arranged around a center axis and matching to the first connectors of the multi plug connector.

Further, US 2019/312 339 suggests a mobile communications antenna that comprises at least one antenna housing and mounted thereto amplifier modules, including plug-in connections. Further, from US 2014/315 408 A1 a RF interconnection module for an antenna is known.

### SUMMARY

In view of the above, an object of the present invention is to improve the electrical connection between radio unit(s) and respective antenna(s). Particularly, the connection shall be easy and fast to install and at the same time provide for a reliable and correct connection.

The object is achieved by an RF multi connector unit for multi-band antennas, an antenna system comprising said RF multi connector unit and a base station including at least one such antenna system as defined in the independent claims. Further aspects are given in the dependent claims.

Particularly, the object is achieved by an RF multi connector unit for connecting a radio unit, particularly a remote radio unit to a multi-band antenna, particularly a base station antenna. The RF multi connector unit comprises multiple RF-plug connectors, which are arranged in an array. Said array of RF-plug connectors defines a common mating direction A. The RF-plug connectors may be common plug connectors, such as (but not limited to) 4.3-10, 2.2-5, 1.5-3.5, NEX10®, 7/16 DIN, APC-7, BNC, Belling-Lee, C-type, F-type, FME, Hirose U. FL, Hirose W. FL, IPXMotorola, MCX, Microdot, MMCX, N-type, QLS, QMA/QN, RCA, SHV, SMA, SMBSMC, TNC, TV aerial plug, UHF/Mini-UHF, 10-32, 2.9 mm (SMA), 7 mm, AMC (UFL), IPEX, MHF, RP-SMA, RP-TNC, SnapN, Triax/Triaxial, Twin BNC/Twinax (BNC), EIA, GR, LEMO 00 and/or Musa.

At least one of the multiple RF-plug connectors is configured to electrically connect an antenna element of multi-band antenna with a port of a radio unit when being plugged to the port. Particularly all RF-plug connectors of the array may be configured to electrically connect a respective one of the antenna elements of an assigned multi-band antenna with a respective port of a radio unit when being plugged to the respective port. Further, each antenna element of a multi-band antenna may be assigned to a respective one of the multiple RF-plug connectors. So when the RF multi connector unit being plugged with a radio unit, each antenna element is connected to an assigned port of a radio unit. Hence, jumper cables become superfluous, leading to an increase in total antenna gain. Further, saving of the jumper cable, may eliminate a plug-in point (due to direct wiring at the antenna/antenna element) and the jumper cable itself, thereby reducing electrical losses. Even further, installation time can be significantly reduced and wiring errors can be effectively avoided. Port pinging, for checking the correct wiring of antenna elements and radio unit ports also becomes superfluous as well as hardware, needed for port pinging. Thus, costs can be further reduced and a safe blind mating process can be provided. Moreover, by providing several different RF-plug connectors, different combinations of multi-band antennas and radio units may be realized. Thereby, a base station site may for example be up-graded by connecting a new radio unit to an existing multi-band antenna of the site or by connecting a new multi-band antenna to an existing radio unit of the site.

To provide a reliable plugging of the RF multi connector unit with a radio unit, at least one of the multiple RF-plug connectors (in particular the at least one of the multiple RF-plug connectors which is configured to electrically connect the antenna element of the multi-band antenna with the port of the radio unit) and preferably all RF-plug connectors of the array) is supported floatingly, at least in a plane being perpendicular to the mating direction A. The floating support allows to compensate for manufacturing tolerances (position and/or orientation) of the ports of a radio unit that are to be connected with respective ones of the RF-plug connectors of the RF multi connector unit.

The floating support may allow for position tolerances in a plane being perpendicular to the mating direction A (x, y-direction) up to ±2 mm, or up to ±1 mm, or up to ±0.5 mm. Further, the floating support may allow for orientation tolerances (angle α, deviating from the mating direction) up to 15°, or up to 8°, or up to 5°, or up to 3°. In a particular aspect, position tolerances in mating direction (or z-direction) can be compensated via the floating support. These may be up to ±2 mm, or up to ±1 mm, or up to ±0.5 mm. Thus, the radio unit can be properly and reliably connected (electrically and mechanically) to the RF multi connector unit.

In an aspect, at least one of the multiple of RF-plug connectors is floatingly supported by a circumferential elastic cuff. The RF-plug connector may be held by elastic cuff in a respective receptacle or recess and may be centered and/or preloaded in a first position/orientation (x=0 mm, y=0 mm, z=0 mm and/or α=0°). During plugging, the RF-plug connector may be deflected (due to the floating support) and may align with an assigned port of the radio unit so as to provide for a proper plugging. The circumferential elastic cuff may be a rubber cuff, a silicone cuff, a elastomeric cuff, a thermoplastic, elastomeric cuff and/or the like. In a particular aspect, the cuff is bellow-shaped. Further the cuff may have recesses, cut-outs and/or rips so as to provide a directional preloading of the RF-plug connector (e.g. in x-direction, and/or y-direction).

Further, the at least one of the multiple of RF-plug connectors (and particularly all RF-plug connectors of the array) may be spring loaded in mating direction A (z-direction). This allows for a floating support in z-direction and/or to adjust a plugging force, so as to ensure proper plugging of the RF-plug connector(s).

The spring loading may be achieved by an elastic element, which may be located on a side of the RF-plug connector opposite to a mating side. Depending on the lateral stiffness of the elastic element, i.e. the force needed to be deflected in x- and/or y-direction, the floating support in the plane perpendicular to the mating direction A can be achieved and/or adjusted.

The elastic element may be any kind of spring, such as a band spring, a flat spring, a leaf springs, a spring clip, a spiral spring, a disc springs, a wave spring, a conical spring, a barrel springs and/or a ring spring. Further, the elastic element may be made of a metal or plastic sheet, wherein multiple elastic elements, may be integrally formed. Hence, an elastic member may be provided inducing multiple spring elements, each spring element being assigned to a respective one of the RF-plug connectors.

The elastic element(s) may be electrically insulated from said RF-plug connector(s). This may be achieved by (at least partially) coating an electrically conductive spring element (e.g. a metallic spring element) with an electric insulator, such as silicone, a thermoplastics and/or an elastomer. Further, the elastic element(s) may be made of an electrically insulative material, such as plastics and or rubber. In a particular embodiment, the elastic element is provided in form of a rubber block.

The array of RF-plug connectors may be a linear array, which may be divided in sub-arrays. An array of RF-plug connectors (and accordingly a sub-array) of RF-plug connectors may be assigned to a specific type of antenna elements (e.g. covering a certain mobile communication frequency band) of the antenna. The array may be a linear array having e.g. a 1×8 structure, which may be divided in two 1×4 sub-arrays. Further a 1×4 array may be divided in two 1×2 sub-arrays. Providing sub-arrays allows to provide more freedom in floating for tolerance adjustment.

For example, at least one RF-plug connector receiving member may be provided. The RF-plug connector receiving member may include receptacles for receiving respective ones of the RF-plug connectors of an array or a sub-array. Further, the RF-plug connector receiving member may be supported floatingly, at least in a plane being perpendicular to the mating direction A. Hence, the array or any one of the subarrays may be supported floatingly, at least in the plane being perpendicular to the mating direction A.

Further, the RF multi connector unit may include at least one bracket element. The bracket element may at least partially surround at least one of the RF-plug connectors. In an aspect, the bracket element at least partially surrounds an assigned RF-plug connector. Further, multiple bracket elements may be provided, each one at least partially surrounding an assigned RF-plug connector of an array and/or a subarray (one by one). In a particular aspect, the multiple bracket elements may be integrally formed as a bracket member, wherein the bracket member is assigned to an array or a sub-array of RF-plug connectors. The bracket member may have receptacles, such as recesses or bores for (at least) partially receiving a respective one of the RF-plug connectors. These receptacles may receive (at least partially) the elastic element and/or may support the circumferential elastic cuff.

The RF multi connector unit further comprises at least one guiding means for guiding a radio unit to be mounted to a locked and electrically connected position. The guiding means may include a guide rail, for receiving and guiding a corresponding guiding element. For example, the guide rail may include an elongated hole, or a slot that receives a corresponding guiding pin (corresponding guiding element) of the radio unit.

In a particular aspect, the guiding means is at least partially oriented in mating direction (particularly, in mating direction A), so as to support the plugging of the RF-plug connectors. In a section that is further away in the mating direction, the guiding means may be oriented differently. Thus, the radio unit may be pivoted and then plugged in mating direction for installing the radio unit.

Further, the guiding means may be shaped as a keyhole track that provides a defined rest position for the plugged radio unit. Even further, the guiding means may provide for a locking element (e.g. a latch or snap element), for locking the plugged radio unit in its final position.

The RF multi connector unit may further comprise at least one securing means, for securing a radio unit to be mounted in a locked and electrically connected position. The securing means may include a threaded member, such as a threaded bolt, a threaded nut (e.g. a union nut), a latching element, a snap element, or the like. For securing the radio unit in its locked and electrically connected position, the securing means may engage with a corresponding securing means provided of the radio unit. In a particular aspect, the securing means may be locked and/or released without the need of additional tooling. For example, a pre-loaded spring arm may secure the radio unit by engaging with a corresponding recess. For releasing the radio unit, the spring arm can be deflected. Subsequently the radio unit can be unplugged.

Further, the securing means may be configured so that the radio unit is held and secured at the antenna by its own weight. This may e.g. be achieved by a wedged portion of the securing means receiving a correspondingly formed wedged portion of the radio unit. When being received in the wedged portion, the radio unit can be centered and secured by its own weight. Further, the securing means may include at least one substantially vertical oriented pin and the radio unit may comprise a corresponding receptacle (or vice versa). When the pin is received in the receptacle, the radio unit is secured by the pin. Further, the pin may center the radio unit. In a certain aspect, the pin may include a conical portion for centering the radio unit.

Further, the RF multi connector unit may comprise at least one alignment funnel. The alignment funnel may be located so as to receive and center a corresponding RF-counter connector to a respective one of the multiple RF-plug connectors. The alignment funnel may be assigned to one of the RF-plug connectors and may be on a side of the RF-plug connector that faces in mating direction A.

Further, multiple alignment funnels may be provided, each one of the alignment funnels may be assigned to a respective one of the RF-plug connectors of an array and/or a subarray. In a particular aspect, the alignment funnel may be integrally formed with the RF-plug connector or with the circumferential elastic cuff. Further, the alignment funnel may be a separate portion, e.g. a sleeve. In a further aspect, multiple alignment funnels may be integrally formed in an alignment member having an array (or sub-array) of alignment funnels, corresponding to the array (or sub-array) of RF-plug connectors. Upon plugging, the alignment funnel receives a corresponding port (or counter connector) of the radio unit and allows the port to be centered relative to the RF-plug connector. Hence, plugging is facilitated and more reliable. Further, the alignment funnel may be floatingly supported (e.g. by being fixed relative to the RF-plug connector). In this case, upon plugging, also the RF-plug connector may be centered and/or oriented relative to the port of the radio unit (or counter connector).

In a further aspect, the RF-multi connector unit comprises at least one functional element. The functional element being electrically connected to at least one of the RF-plug connectors. Hence, when the RF-plug connector is plugged to a port of a radio unit so as to electrically connect an antenna element and the respective port of the radio unit, a signal being transmitted via said RF-plug connector has to pass the functional element. Depending on the radio unit and the antenna elements, different functional elements may be assigned to respective RF-plug connectors.

Further, the functional element is configured to manipulate a signal that is transmitted via the at least one RF-plug connector. In a particular aspect, the functional element includes at least one of the following:
a filter, particularly a signal filter,
a calibration board,
a bias-T, particularly a smart bias-T,
an integrated digital converter, the digital converter optionally including an application specific integrated circuit, ASIC, and/or
at least one control unit, the control unit providing additional feature site equipment.

In case the functional element includes a filter, the filter may allow specific frequencies to pass while attenuating or blocking others.

For example, the filter may be a low pass filter (LPF), which allows frequencies below a certain cutoff frequency to pass through while attenuating higher frequencies. In another aspect, the filter may be a high pass filter (HPF), that permits frequencies above a particular cutoff frequency to pass while suppressing lower frequencies. Even further, the filter may be a band pass filter (BPF), which allows a specific range or band of frequencies to pass through while attenuating frequencies outside that range.

In a further aspect, the filter may be a band reject filter (BRF), that blocks a specific range or band of frequencies while allowing frequencies outside that range to pass.

Further, the filter may be or may include a duplexer (or multiplexer) that enables simultaneous transmission and reception on the same frequency band. Even further, the functional element may include at least one cavity filter, at least one surface acoustic wave (SAW) filter, at least one interdigital filter, at least one microstrip filter, at least one crystal filter, at least one tunable filter, and/or the like.

Further, the functional element may be or may include a calibration board. A is a calibration board allows calibration and/or verification of measurements in RF and microwave circuits, particularly related to the port(s) of the radio unit and/or the antenna elements. For example, the calibration board may include a short-open-load (SOL) calibration device, a through-reflect-line (TRL) calibration device, a coplanar waveguide (CPW) calibration device, and/or the like. When including a calibration board, systematic errors and uncertainties in measurements caused by the imperfections in the test setup, connectors, cables, or the measurement equipment itself can be eliminated.

In case the functional element includes a Bias-T, signals carrying power and signals carrying DC bias voltage can be combined and/or separated. Accordingly, both, the RF/microwave signal and the DC bias can share the same transmission path, i.e. the same RF-plug connector.

A smart Bias-T is an enhanced version of the traditional Bias-T and incorporates additional features or functionalities, such as:

Remote Monitoring and Control: Said smart Bias-T may feature remote monitoring capabilities, allowing a user to monitor parameters such as voltage, current, or temperature remotely. It may also include the ability to adjust bias voltage or power settings remotely.

Integrated Sensors: Said smart Bias-T may integrate sensors to measure various parameters like temperature, humidity, or RF power levels, providing more comprehensive information about the system's operating conditions.

Advanced Control Interfaces: Said smart Bias-T may offer more sophisticated control interfaces, enabling programmable adjustments or automatic regulation of bias voltage or power levels based on pre-defined criteria or feedback mechanisms.

Diagnostic and Self-Calibration Functions: Said smart Bias-T may include self-diagnostic features to detect faults or issues in the biasing circuitry, ensuring more reliable operation and facilitating easier maintenance.

These enhanced functionalities in smart Bias-Ts aim to improve the efficiency, reliability, and control of the biasing process in the RF multi connector unit, and providing greater flexibility and remote management capabilities.

In case the functional element includes an integrated digital converter, the converter may be or include an Analog-to-Digital Converter (ADC) or Digital-to-Analog Converter (DAC). In a particular aspect, the integrated digital converter, whether an ADC or DAC, is fabricated on a single integrated circuit (IC) chip, which allows for compactness, integration with other components, and often provides improved performance characteristics. The integrated converters may come in various architectures, resolutions, speeds, and accuracy levels to meet the specific requirements of different applications.

Even further, the functional element may provide at least on control unit, the control unit providing additional feature site equipment, such as a network tracker, a site absorber and/or the like. With providing a functional element, additional functionality can easily be installed and/or retrofitted without having to replace the antenna, antenna elements and/or the radio unit.

In a particular aspect, the functional element may be located within the RF-multi connector unit so that it is at least partially arranged between a radio unit and a multi-band antenna, when the multiple RF-plug connectors are plugged to respective ports of the radio unit, so as to electrically connect an antenna element of a multi-band antenna with a port of a radio unit. By arranging the functional element (at least partly) between the radio unit and the multiband antenna, the available installation space can be ideally utilized. The additional functional element requires little or even no installation space, which increases the external dimensions of the system, including the antenna and the radio unit.

In a further aspect, the multiple plug connectors define a first set of RF-plug connectors having a first mating direction A. This first set is configured to be mated with respective ports of a radio unit. Further, the RF multi connector unit may comprise a second set of RF-plug connectors defining a second common mating direction B. The second set is configured to be mated with respective ports of a multi-band antenna the second set of RF-plug connectors may be configured as outlined above with respect to the first set. I.e. the RF-plug connectors of the second set may be supported floatingly, at least in a plane being perpendicular to the mating direction B.

Further, at least one of the multiple of RF-plug connectors of the second set may be floatingly supported by a circumferential elastic cuff and/or spring loaded in mating direction B, e.g. by means of an elastic element that may be electrically insulated from said RF-plug connector.

The RF-plug connectors of the second set (or at least a sub-array thereof) may be supported floatingly, at least in a plane being perpendicular to the mating direction B. In a particular aspect, a bracket element may surround at least one of the RF-plug connectors of the second set.

In a further aspect, the RF multi connector unit may comprise at least one second guiding means, for guiding the RF multi connector unit to a locked and electrically connected position on a back side of a multiband antenna. In an even further aspect, the RF multi connector unit further comprises at least one second securing means, for securing the RF multi connector unit in a locked and electrically connected position on a back side of a multiband antenna. Said securing means may be or may include a threaded bolt, a snap lock, a latch and/or the like.

According to an aspect, at least one RF-plug connector of the first set is assigned to an RF-plug connector of the second set. By providing a second set of RF Plug connectors, the RF multi connector unit can be easily and reliably connected to a multiband antenna (via the second set of RF-plug connectors) and a radio unit can be easily connected with the RF multi connector unit (via the first set of RF-plug connectors).

In a particular aspect, the second common mating direction B may differ from the first mating direction and may be substantially perpendicular to the first mating direction A. Thus, the orientation of the radio unit, when being connected to the multiband antenna via the RF multi connector unit can be adapted.

The RF multi connector unit may further comprise a release element. The release element being adapted to unlock a mounted radio unit from a locked and electrically connected position, and/or the release element may be adapted to unlock a RF multi connector unit from a locked and electrically connected position on a back side of a multiband antenna. The release element may include a pre-loaded elastic element and/or a pushing pin that can be released/pushed to move the radio unit (or the RF multi connector unit) out of the locked and electrically connected position. Further, the release element may include a threaded rod. When being screwed in, the threaded rod may force the radio unit (or the RF multi connector unit, respectively) in an unlocked position. Thus, the radio unit (and/or the RF multi connector unit) can be unmounted without the need of additional tooling.

In a further aspect, the RF multi connector unit may include at least one power connector and/or at least one sensor signal line connector. Hence, not only the RF-ports of a radio unit can be connected but also any other type of connector can be connected upon plugging the RF multi connector unit. Thereby installation of a radio unit is facilitated and incorrect and/or incomplete wiring can be effectively prevented.

The object is further achieved by an antenna system, the antenna system comprising at least one RF-multi connector unit as described above and at least one multi-band antenna. The multi-band antenna having multiple antenna elements. At least one of the multiple RF-plug connectors of the RF-multi connector unit is electrically connected to an antenna element of multi-band antenna. Particularly all RF-plug connectors of the array of the RF-multi connector unit may be electrically connected to a respective one of the antenna elements of the multi-band antenna. The electrical connection may be a lug connection or a permanent connection, such as a welded, crimped and/or soldered connection.

In a particular aspect, the antenna system is an antenna system for a wireless communication base station and may be suited for 2G, 3G, 4G and/or 5G communication and/or upcoming standards, e.g. 6G.

The antenna system may further comprise at least one radio unit, wherein the radio unit is electrically connected to the multi-band antenna by means of the RF-multi connector unit. The radio unit may preferably be securely held by its own weight, e.g. via a securing means, as described forth above.

The antenna system may further comprise an adapter element, the adapter element being configured to change a plug configuration of the array and/or to change a mating direction defined by the array of RF-plug connectors. For example, the adapter element may comprise a corresponding array (or sub-array) of adapter connectors. The adaptor connectors including an antenna side and a radio unit side. The antenna side is configured to mate with the multiple RF-plug connectors of the RF-multi connector unit and the radio unit side is configured to mate with the ports (counter connectors) of a radio unit. By inter wiring the antenna side and the radio unit side respectively, the plug configuration of the array can be changed. Further, by orienting the antenna side and the radio unit side differently, a mating direction defined by the array of RF-plug connectors can be changed.

The object is further achieved by a base station for mobile communication, the base station including at least one antenna system as outlined above, and base band unit being in communication with the antenna system. In a certain aspect, the base station may have multiple antennas and/or antenna systems and/or may be a distributed base station.

### BRIEF DESCRIPTION OF THE DRAWINGS

Further features and advantages will be apparent from the following description as well as the accompanying figures, to which reference is made. The figures show in detail:

FIG. 1 a schematic perspective view of an antenna system according to an embodiment of the invention;

FIG. 2 a schematic perspective view of an RF-multi connector unit according to an embodiment of the invention;

FIG. 3 an exploded view of the RF-multi connector unit of FIG. 2;

FIGS. 4A and 4B a plugging sequence of a radio unit according to an embodiment of the invention;

FIG. 5 a schematic illustration of an RF multi connector unit according to an embodiment of the invention;

FIGS. 6A and 6B schematic perspective views of a further RF multi connector unit according to an embodiment of the invention, and

FIG. 7 a schematic illustration of a base station according to an embodiment of the invention.

### DETAILED DESCRIPTION

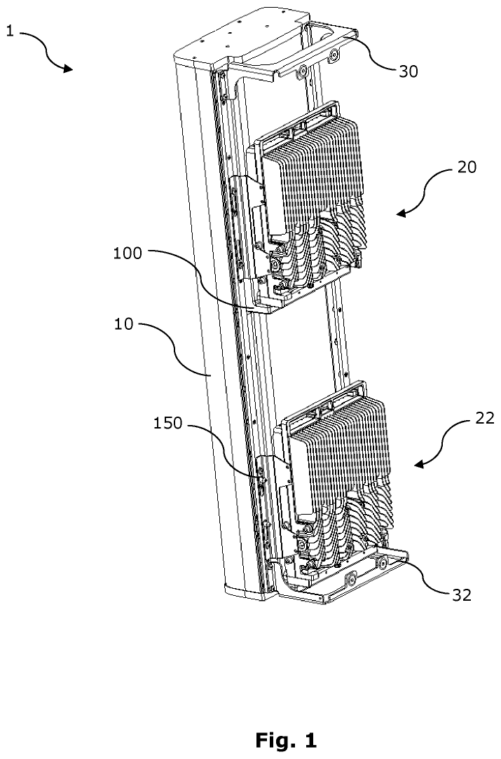

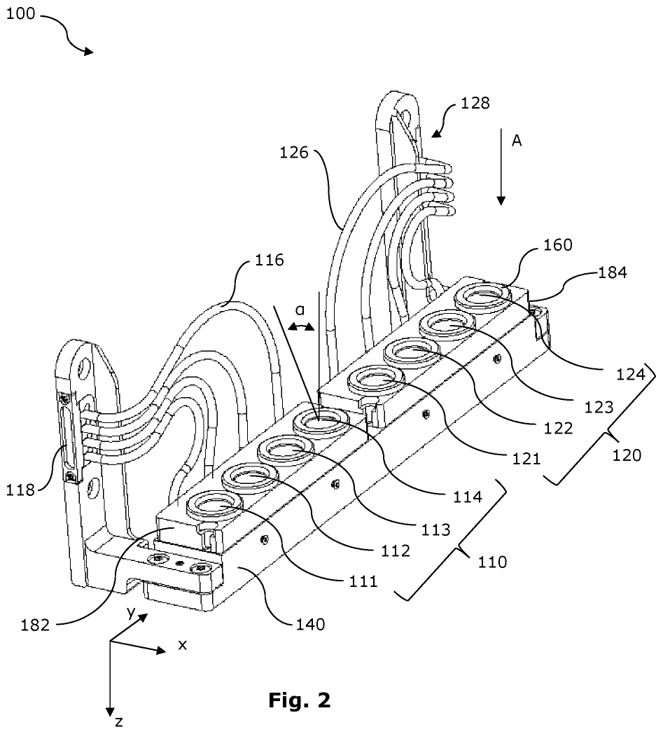

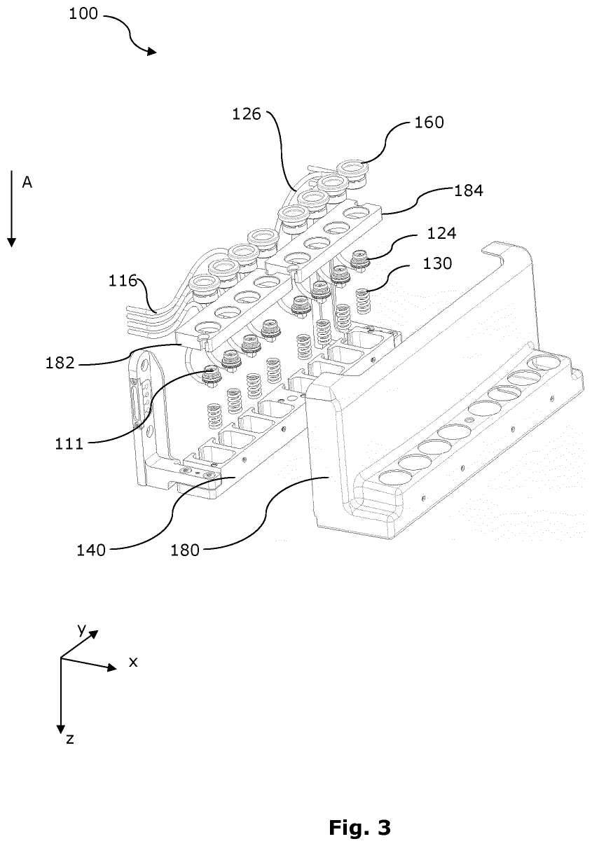

FIG. 1 is a schematic perspective view of an antenna system 1 for a wireless communication base station according to an embodiment. The antenna system 1 comprises a multi-band antenna 10, having multiple antenna elements (not shown). Further, the antenna system 1 comprises at least one (here two) radio units 20, 22. The radio units 20, 22 being electrically connected to the multi-band antenna 10 by means of RF-multi connector units 100. Those are shown in greater detail in FIGS. 2 and 3. The antenna system includes fastening elements 30, 32, which serve for mounting the antenna system on a mast, a building and/or the like.

FIG. 2 is a schematic perspective view of an RF-multi connector unit 100 according to an embodiment. The RF-multi connector unit 100 serves for mounting and electrically connecting a radio unit 20, 22 to a multi band antenna 10.

The RF multi connector unit 100 comprises multiple RF-plug connectors 111, 112, 113, 114; 121, 122, 123, 124. Those RF-plug connectors are arranged in an array, respectively in two 1×4 sub-arrays 110, 120. The array defines a common mating direction A for plugging counter connectors (or ports) of a radio unit. The RF-plug connectors can be electrically connected to respective ones of antenna elements of the multi-band antenna 10. This is achieved via cables 116, 126 and antenna interface connectors 118, 128, which may be plug connectors.

Each one of the RF-plug connectors 111, 112, 113, 114; 121, 122, 123, 124 is supported floatingly in a plane being perpendicular to the mating direction A, i.e. in x-direction and y-direction, as well as in the mating direction A (also denoted as z-direction). Further, each of the RF-plug connectors may be supported by a circumferential elastic cuff (not shown). Via the elastic cuffs, the RF-plug connectors may be centered in a first, initial position and orientation. Due to the floating support each one of the RF-plug connectors can be deflected individually and can align with an assigned port of the radio unit so as to provide for a proper plugging. For facilitating the plugging and alignment of the RF-plug connectors 111, 112, 113, 114; 121, 122, 123, 124 and the ports of the radio unit alignment funnels 160 are provided. Those alignment funnels 160 may be integrally formed with the RF-plug connectors or may be provided as separate sleeve (as shown). The alignment funnels 160 are located so as to receive and center a corresponding RF-counter connector (i.e. port/counter connector) to a respective one of the multiple RF-plug connectors. Further, each one of the alignment funnels 160 may be floatingly supported (e.g. in x-, y- and/or z-direction) in a respective receptacle of one of the RF-plug connector receiving members 182, 184.

As best seen in FIG. 3, each one of the multiple of RF-plug connectors 111, 112, 113, 114; 121, 122, 123, 124 is spring loaded in mating direction A by means of an elastic element 130. The elastic elements may be electrically insulated from said RF-plug connectors. Here, the elastic elements are provided in form of a spiral spring. This allows for a floating support in z-direction.

Further, the RF multi connector unit 100 includes a bracket member. Said bracket member is assigned to the sub-arrays 110, 120 of RF-plug connectors 111, 112, 113, 114; 121, 122, 123, 124. The bracket member has receptacles for receiving a respective one of the RF-plug connectors. Thus, the bracket member forms multiple bracket elements 140.

Further, a housing 180 is provided for housing the RF-plug connectors 111, 112, 113, 114; 121, 122, 123, 124. The RF-plug connectors 111, 112, 113, 114; 121, 122, 123, 124 may be held in an RF-plug connector receiving member 182, 184 of said housing. Here, the RF-plug connector receiving member 182 is assigned to the first sub-array 110 of RF-plug connectors 111, 112, 113, 114 and the RF-plug connector receiving member 184 is assigned to the second sub-array 120 of RF-plug connectors 121, 122, 123, 124. As shown in FIGS. 2 and 3, the RF-plug connector receiving member 182 includes receptacles for receiving respective ones of the RF-plug connectors 111, 112, 113, 114 of the sub-array 110 and the RF-plug connector receiving member 184 includes receptacles for receiving respective ones of the RF-plug connectors 121, 122, 123, 124 of the sub-array 120. Further, the RF-plug connector receiving members 182, 184 may be supported floatingly, at least in a plane being perpendicular to the mating direction A, i.e. in x-direction and/or y-direction. Hence, the subarrays 110, 120 may be supported floatingly.

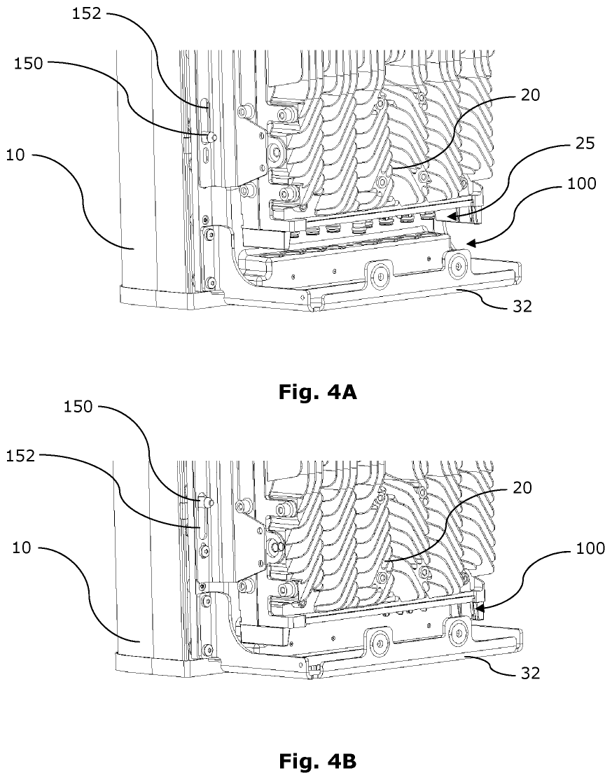

FIG. 4A and B show a plugging sequence of a radio unit 20 using an RF multi connector unit 100. In FIG. 4A, the radio unit 20 is shown prior to plugging. In FIG. 4B, the radio unit 20 is in the plugged and electrically connected position. All ports 25 (counter connectors) of the radio unit 20 can be plugged with corresponding RF-plug connectors of the RF multi connector unit 100 at the same time.

The RF multi connector unit comprises at least one guiding means 150 for guiding the radio unit 20 to be mounted to a locked and electrically connected position (cf. FIG. 4B). The guiding means 150 is provided in form of a guiding pin, protruding in x-direction. The guiding pin 150 can be received in a guide rail 152 (corresponding guiding element). The guide rail is formed as an elongated hole, extending in mating direction A of the ports 25.

When mounting the radio unit 20, the guiding pins 152 guides and orientates the radio unit 20 until it reaches its locked and electrically connected position. A hard stop defines this locked and electrically connected position of the radio unit 20. In this locked position, the RF-plug connectors and the ports are interconnected and the radio unit 20 is securely held on a back side of antenna 10. Further, the radio unit may be securely held by its own weight in the position shown in FIG. 4B. For releasing the radio unit 20, the radio unit 20 can be lifted. No tooling is required. During mounting, the ports 25 of the radio unit 20 are aligned with respective ones of RF-plug connectors. This alignment is achieved due to the floating support of the RF-plug connector receiving members 182, 184 and/or due to the floating support of the RF-plug connectors themselves. Hence, existing tolerances that may lead to misalignments between the ports of the radio unit 20 and the RF-plug connectors can be compensated via the floating support and the pre-alignment provided by the alignment funnels 160.

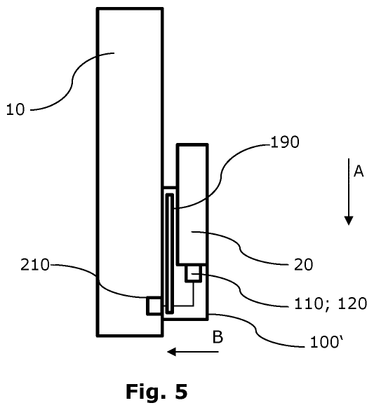

FIG. 5 a schematic illustration of an RF multi connector unit 100′ according to an embodiment of the invention. The RF multi connector unit 100′ includes a first set of RF-plug connectors 110, 120 and a second set of RF-plug connectors 210. An RF-plug connector of the first set is assigned to and electrically connected to a respective RF-plug connector of the second set.

The RF-plug connectors of the first set are configured to plug with respective ports of a radio unit 20. The mating direction of the first set is A. The RF-plug connectors of the second set 210 are configured to plug with respective ports of a multiband antenna 10. The mating direction of the second set is B, wherein the second common mating direction B is substantially perpendicular to the first mating direction A.

Further, the RF multi connector unit 100′ comprises at least one functional element 190. The functional element 190 is electrically connected to at least one of the RF-plug connectors of the first set and to at least one of the RF-plug connectors of the second set. Further, the functional element 190 is configured to manipulate a signal being transmitted via the respective RF-plug connectors. The functional element 190 may include a filter, a calibration board, a bias-T, an integrated digital converter, a control unit and/or the like.

As shown, the functional element 190 may be at least partially arranged between the radio unit 20 and the multi-band antenna thereby providing a small form factor of the antenna system.

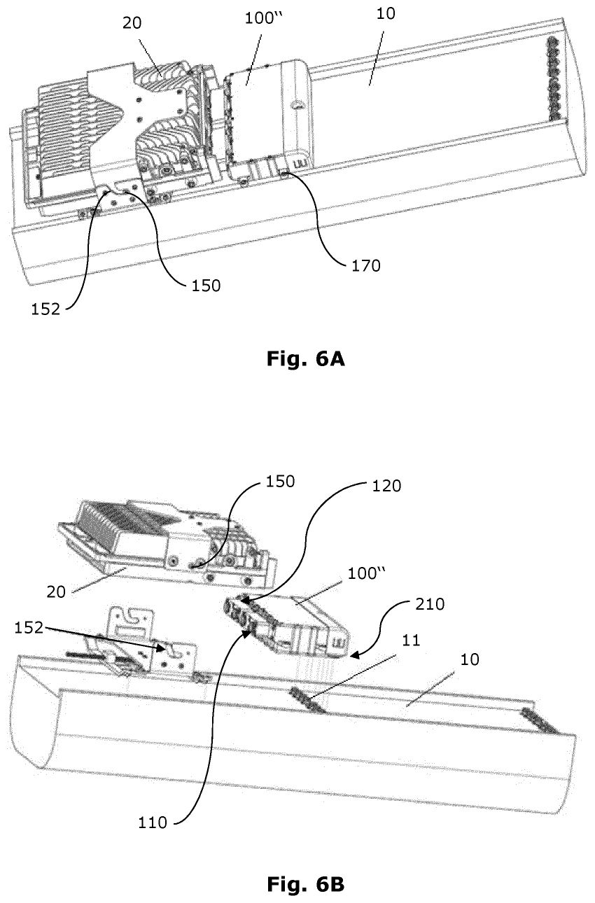

FIG. 6A gives a perspective view of an antenna system. The system comprises an RF-multi connector unit 100″, a multi-band antenna 10, having multiple antenna elements and a radio unit 20. In FIG. 6B, an exploded view of the system is given.

The RF-multi connector unit 100″ includes a second set of RF-plug connectors 210, which can be plugged to respective ports 11 of the multiband antenna 10. For securing the RF-multi connector unit 100″ on a back side of the multiband antenna 10, screws 170 (or any other suitable fasting means) may be used. The radio unit 20, particularly the ports thereof are plugged to sub-arrays 110, 120 of RF-plug connectors of a first set of RF-plug connectors. For securing the radio unit on the back side of the multi-band antenna in a locked and electrically connected position, a guiding means 150, particularly a guiding pin, may be provided. The guiding pin 150 can be received in a guide rail 152 (corresponding guiding element). The guide rail is formed as an elongated hole, extending at least partially in mating direction A. When mounting the radio unit 20, the guiding pins 152 guides and orientates the radio unit 20 until it reaches its locked and electrically connected position.

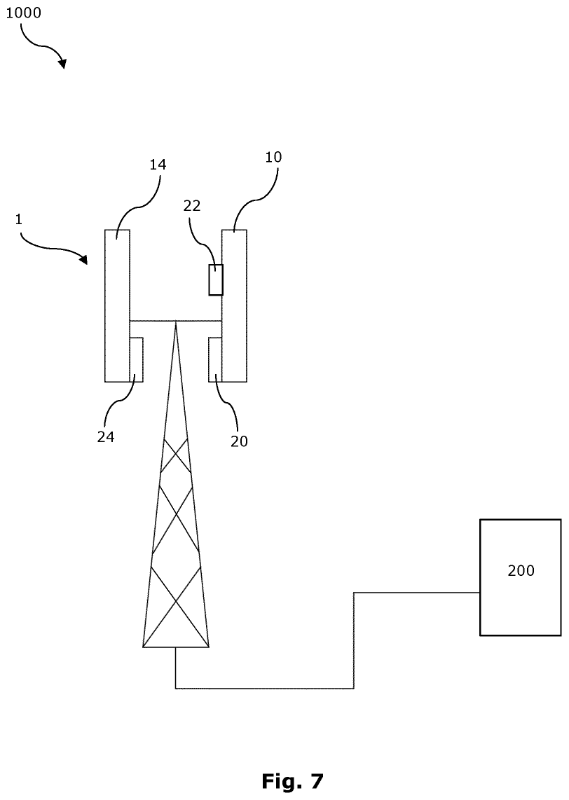

FIG. 7 shows a schematic illustration of a base station 1000. The base station incudes a base band unit (BBU) 200, which is in communication with radio units 20, 22, 24. Those radio units may be remote radio units, which can be remotely controlled by the BBU. The radio units 20, 22 are assigned to a first multi band antenna 10 of the base station and the radio unit 24 is assigned to a second multi band antenna 14 of the base station 1000.

The BBU 200 (or CU) is connected via respective data lines to the radio units 20, 22, 24. Each one of the radio units 20, 22, 24 powers a respective base station antenna (i.e. multiband antennas 10, 14), or at least parts thereof. The radio units 20, 22, 24 are operatively coupled to the multi band antennas 10, 14 via RF-multi connector units (not shown here).

Some of the embodiments contemplated herein are described more fully with reference to the accompanying figures. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

### LIST OF REFERENCE SIGNS

1 Antenna system
10 Multi band antenna (e.g. a base station antenna)
14 Multi band antenna (e.g. a base station antenna)
11 ports of multi band antenna
20 Radio Unit (e.g. a RRU)
22 Radio Unit (e.g. a RRU)
25 ports (counter connectors)
30 Fastening element
32 Fastening element
100 RF multi connector unit
100′ RF multi connector unit
100″ RF multi connector unit
110 (sub)array of RF-plug connectors (of first set)
111 RF-plug connector
112 RF-plug connector
113 RF-plug connector
114 RF-plug connector
116 cable
118 antenna interface connector
120 (sub)array of RF-plug connectors (of first set)
121 RF-plug connector
122 RF-plug connector
123 RF-plug connector
124 RF-plug connector
126 cable
128 antenna interface connector
130 elastic element
140 bracket element
150 guiding means (e.g. pin)
152 guide rail
160 alignment funnel
170 screw
180 housing
182 RF-plug connector receiving member
184 RF-plug connector receiving member
190 functional element
200 base band unit (BBU)
210 second set of RF-plug connectors
1000 base station
A mating direction

1. An RF multi connector unit (100) for connecting a radio unit (20, 22) to a multi-band antenna (10), the RF multi connector unit (100) comprising:
multiple RF-plug connectors (111, 112, 113, 114; 121, 122, 123, 124), the RF-plug connectors being arranged in an array (110; 120) defining a common mating direction (A), wherein
at least one of the multiple RF-plug connectors (111, 112, 113, 114; 121, 122, 123, 124) is configured to electrically connect an antenna element of a multi-band antenna (10) with a port of a radio unit, when being plugged to the port, and wherein
at least one of the multiple RF-plug connectors (111, 112, 113, 114; 121, 122, 123, 124) is supported floatingly, at least in a plane being perpendicular to the mating direction (A).

2. The RF multi connector unit (100) according to claim 1, wherein
at least one of the multiple of RF-plug connectors (111, 112, 113, 114; 121, 122, 123, 124) is floatingly supported by a circumferential elastic cuff.

3. The RF multi connector unit (100) according to any one of claims 1 or 2, wherein
at least one of the multiple of RF-plug connectors (111, 112, 113, 114; 121, 122, 123, 124) is spring loaded in mating direction (A).

4. The RF multi connector unit (100) according to the preceding claim, wherein
the at least one of the multiple of RF-plug connectors (111, 112, 113, 114; 121, 122, 123, 124) is spring loaded in mating direction (A) by means of an elastic element (130), being electrically insulated from said RF-plug connector.

5. The RF multi connector unit (100) according to any preceding claim, wherein the array is a linear array (110; 120) which may be divided in subarrays (110, 120), and/or wherein
the array or any one of the subarrays (110; 120) may be supported floatingly, at least in a plane being perpendicular to the mating direction (A).

6. The RF multi connector unit (100) according to any preceding claim, further comprising
at least one bracket element (140), the bracket element at least partially surrounding at least one of the RF-plug connectors (111, 112, 113, 114; 121, 122, 123, 124).

7. The RF multi connector unit (100) according to any preceding claim, wherein
the RF multi connector unit (100) further comprises at least one guiding means (150), for guiding a radio unit (20, 22) to be mounted to a locked and electrically connected position.

8. The RF multi connector unit (100) according to any preceding claim, wherein the RF multi connector unit (100) further comprises at least one securing means, for securing a radio unit (20, 22) to be mounted in a locked and electrically connected position.

9. The RF multi connector unit (100) according to any preceding claim, further comprising at least one alignment funnel (160), the alignment funnel (160) being located so as to receive and center a corresponding RF-counter connector to a respective one of the multiple RF multi connectors.

10. The RF multi connector unit (100) according to any preceding claim, further comprising at least one functional element (190), the functional element (190) being electrically connected to at least one of the RF-plug connectors (111, 112, 113, 114; 121, 122, 123, 124), wherein the functional element is configured to manipulate a signal being transmitted via the at least one RF-plug connector, wherein the functional element (190) includes at least one of the following:
a filter, particularly a signal filter,
a calibration board,
a bias-T, particularly a smart bias-T,
an integrated digital converter, the digital converter optionally including an application specific integrated circuit, ASIC, and/or
at least one control unit, the control unit providing additional feature site equipment.

11. The RF multi connector unit (100) according to claim 10, wherein the functional element (190) is located within the RF-multi connector unit (100) so that it is at least partially arranged between a radio unit (20) and a multi-band antenna (10), when the multiple RF-plug connectors (111, 112, 113, 114; 121, 122, 123, 124) are plugged to respective ports of the radio unit (20), so as to electrically connect an antenna element of a multi-band antenna (10) with a port of a radio unit.

12. The RF multi connector unit (100) according to any preceding claim, wherein
the multiple plug connectors (111, 112, 113, 114; 121, 122, 123, 124) define a first set of RF-plug connectors having a first mating direction (A), wherein
the first set is configured to be mated with respective ports of a radio unit, and wherein
the RF multi connector unit (100) further comprises a second set of RF-plug connectors defining a second common mating direction (B), the second set is configured to be mated with respective ports of a multi-band antenna (10), wherein
at least one RF-plug connector of the first set is assigned to a RF-plug connector of the second set.

13. The RF multi connector unit (100) according to claim 11, wherein the second common mating direction (B) is substantially perpendicular to the first mating direction (A).

14. The RF multi connector unit (100) according to any preceding claim, further comprising a release element, the release element being adapted to unlock a mounted radio unit (20, 22) from a locked and electrically connected position, and/or the release element is adapted to unlock the RF multi connector unit (100) from a locked and electrically connected position on a back side of a multi-band antenna (10).

15. The RF multi connector unit (100) according to any preceding claim, further including at least one power connector and/or at least one sensor signal line connector.

16. An antenna system (1) particularly for a wireless communication base station (1000), the antenna system (1) comprising
at least one RF-multi connector unit (100) according to any one of claims 1 to 15; and
at least one multi-band antenna (10), having multiple antenna elements, wherein
at least one of the multiple RF-plug connectors (111, 112, 113, 114; 121, 122, 123, 124) of the RF-multi connector unit (100) is electrically connected to an antenna element of multi-band antenna.

17. The antenna system (1) according to claim 16, further comprising at least one radio unit (20, 22), the radio unit being electrically connected to the multi-band antenna (10) by means of the RF-multi connector unit (100), wherein the radio unit is held by its own weight.

18. The antenna system (1) according to claim 16 or claim 17, the antenna system (1) further comprising an adapter element, the adapter element being configured to
change a plug configuration of the array (110, 120), and/or to
change a mating direction defined by the array (110, 120).

19. A base station (1000) for mobile communication, the base station (1000) including at least one antenna system (1) according to any one of claims 16 to 18 and a base band unit (200), being in communication with the antenna system (1).
